(19) United States
(12) Patent Application Publication
(10) Pub. No.: US 2011/0206799 A1
(43) Pub. Date: Aug. 25, 2011

(54) Agglomerated Feed and Method for Production Thereof

(75) Inventors: Andrea Hermsmeyer, Oberuzwil (CH); Patrick Harteneck, St. Gallen (CH); Stefan Vontobel, Frauenfeld (CH)

(73) Assignee: BUHLER AG, Uzwil (CH)

(21) Appl. No.: 13/015,784

(22) Filed: Jan. 28, 2011

Related U.S. Application Data
(60) Provisional application No. 61/306,049, filed on Feb. 19, 2010.

(51) Int. Cl. A23K 1/16; A23K 1/24; A23K 1/165; A23K 1/175; A23K 1/18; A23P 1/02; A23P 1/10; A23P 1/12

(52) U.S. Cl. 426/2; 426/635; 426/72; 426/61; 426/74; 426/285

(57) ABSTRACT

An agglomerated feed includes grain particles having an average size in the range of 0.8 mm to 2.5 mm. The agglomerated particles have an average size in the range of 1.0 mm to 5.5 mm.

The present invention is directed to an agglomerated feed, in particular to the average size of the agglomerated feed and the average size of particles comprised in the agglomerated feed.

It is known in the art that poultry feed represents the most significant cost of broiler production and that poultry feed of fine particle size, i.e. up to 1.5 mm in the largest dimension of the particle, is detrimental to the weight gain of broiler chicks used in broiler production (Behnke et al, Effect of Feed Processing on Broiler Performance).

It was thus an object of the present invention to overcome the drawbacks of the known prior art, especially to address the aforementioned problems, in particular to improve the growth performance of poultry and to decrease the cost of poultry feed necessary to achieve said growth.

This object was solved by the agglomerated feed and related method for producing agglomerated feed according to the independent claims.

In particular, the invention pertains to:

a)

Agglomerated feed comprising agglomerated particles, wherein:

grain particles have an average size in the range of d50=0.8 mm to d50=2.5 mm, preferably of d50=1 mm to d50=2.2 mm, more preferably of d50=1.1 mm to d50=2.0, particularly preferred of d50=1.2 to d50=1.8 mm,

wherein said agglomerated particles have an average size in the range of d50=1.0 mm to d50=5.5 mm, preferably of d50=1.5 mm to d50=4.5 mm, more preferably of d50=2.0 mm to d50=4 mm, particularly preferred of d50=2.5 to d50=3.5 mm.

Sieving is carried out according to DIN 66165 (Teil 2), April 1987. Samples were pretreated with a conventional product separator (for obtaining representative laboratory analytical subsamples from particulate laboratory samples). Sieving was done in the dry state with small sieves (item 6.1.1 of DIN 66165 (Teil 2)), with a sieving machine (item 7 of DIN 66165 (Teil 2)). The sample amount was in the range of 100 g to 400 g; preferably 105 g to 200 g; most preferably 110 g to 150 g. Round sieves with a diameter of 20 cm were used, as follows: 3.15 mm (DIN 4188; ISO 565-T.1); 2.5 mm (DIN 4188; ISO 565-T.1); 2 mm (DIN 4188; ISO 565-1972); 1 mm (DIN 4188; ISO 565-T.1). No sieving additives were used. Sieving was carried out for 2 to 5 minutes; preferably 2.5 to 4; particularly preferred 3 minutes.

In the meaning of the present invention, the d50 value is that sieve mesh size at which 50% of the total of the weight of a sample is retained by said sieve.

One advantage of said agglomerated feed is the improved gain of weight of poultry when the same amount of feed is fed to the poultry compared to feed according to the state of the art. For example, when the agglomerated feed according to the invention is used, 1.4 kg of feed is used within the first 28 days of poultry farming to achieve a weight gain of 1 kg of the poultry. With feed of fine particle size, 1.5 kg of feed is necessary to achieve the same weight gain of 1 kg of the poultry. After 37 days of poultry farming, 1.6 kg of agglomerated feed according to the invention is necessary to achieve a weight gain of 1 kg of the poultry. With feed of fine particle size however, 1.7 kg of feed is necessary to achieve the same weight gain of 1 kg of the poultry.

A further advantage is the increased weight of the average poultry when the agglomerated feed according to the invention is fed compared to feed of fine particle size. For example, after 37 days of poultry farming, the poultry feeding on agglomerated feed have a weight of 2.3 kg compared to 2.2 g of the poultry feeding on feed of fine particle size.

b)

Agglomerated feed as aforementioned, wherein the grain is corn.

c)

Agglomerated feed as aforementioned, based on starch containing cereals comprising at least one of the ingredients: soybean meal, soy oil, rape seed meal, meat and bone meal, limestone, dicalcium phosphate, salt, DL-methionine, sodium carbonate, threonine, herring meal, potato protein, choline L, L-lysin, enzymes for amelioration of intestinal flora, acids, vitamins, preservative agents, Monteban®.

d)

Agglomerated feed as aforementioned, wherein the gelatinization of starch comprised in said agglomerated feed is less than 25%, preferably less than 21% and more preferably less than 18%.

The degree of starch gelatinization is preferably assessed by measuring the susceptibility of starch in the sample toward enzymatic degradation. Towards this end, samples are incubated with beta-amylase (b-Amylase (ex Barley) Code 10398-D; NBS Biologicals 14 Tower Square, Huntingdon, Cambs, PE297TD9) at 30° C. for 2 h and the degradation product maltose is determined by iodometric titration (determination of reducing sugars with ferricyanidine method). The degree of gelatinization is calculated by relating the value for the samples to the fully gelatinized reference (obtained by pressure cooking of a sample at 120° C. for 30 min before incubation with beta-amylase).

e)

Agglomerated feed as aforementioned, wherein the density of an agglomerate of said agglomerated feed is less than 1.6 g/ml, preferably less than 1.48 g/ml, more preferably less than 1.42 g/ml and particular preferably less than 1.36 g/ml; in any case, the density of the agglomerated feed is higher than 0.1 g/ml. Agglomerate density is preferably measured with a constant volume gas pycnometer (Quantachrom) operating with Helium.

f)

Agglomerated feed as aforementioned, wherein said agglomerated feed exhibits an abrasion resistance when subjected to shear forces according to Schulze such that at a normal pressure of 10,000 Pa and a shear distance of 25 cm the d90 of said agglomerated feed is reduced to the range of about 1 mm to about 2 mm in absolute values; and/or the d90 of said agglomerated feed is reduced to the range of about 1 mm to about 2 mm (preferably about 0.5 mm to about 2 mm) in relation to the absolute values of the sample prior to the abrasion test. The calculation is done as follows, by means of example:

| | | | weight % retained, in relation |
|---|---|---|---|
| | mesh size | weight % | to sample prior to test |
| Sample | [mm] | retained | (taken as 100% each): |
| prior to test | 3.15 | 87 | |
| prior to test | 2.50 | 94 | |
| prior to test | 2.00 | 98 | |
| Prior to test | 1.00 | 99 | |
| after test | 3.15 | 63 | 72 |
| after test | 2.50 | 74 | 79 |
| after test | 2.00 | 81 | 83 |
| after test | 1.00 | 92 | 93 |

In accordance with the definition given in item a), the d90 value is that sieve mesh size at which 90% of the total of the weight of a sample is retained by said sieve.

The abrasion test was conducted according to Schulze (D. Schulze: Pulver und Schüttgüter: Flieβeigenschaften und Handhabung, Springer, 2009, ISBN 3540884483, page 248 ff.) the disclosure of which is herein incorporated by reference.

g)

Agglomerated feed as aforementioned, wherein said agglomerated feed exhibits an abrasion resistance when subjected to shear forces according to Schulze, such that at a normal pressure of 20,000 Pa and a shear distance of 25 cm, the d90 of said agglomerated feed is reduced to below about 1 mm in absolute values; and/or the d90 of said agglomerated feed is reduced to below about 1 mm in relation to the absolute values of the sample prior to the abrasion test. The calculation is done as follows, by means of example:

| | | | weight % retained, in relation |
|---|---|---|---|
| | mesh size | weight % | to sample prior to test |
| Sample | (mm) | retained | (taken as 100% each): |
| prior to test | 3.15 | 87 | |
| prior to test | 2.50 | 94 | |
| prior to test | 2.00 | 98 | |
| Prior to test | 1.00 | 99 | |
| after test | 3.15 | 45 | 52 |
| after test | 2.50 | 56 | 60 |
| after test | 2.00 | 64 | 65 |
| after test | 1.00 | 81 | 82 |

h)

Agglomerated feed as aforementioned, wherein said agglomerated feed has a PDI of at least 70%, preferably of at least 80%, more preferably of at least 90%, even more preferably of at least 95% and most preferably of at least 99%.

A pellet's integrity can be measured by its pellet durability index (“PDI”) as measured via a procedure similar to that described in Feed Manufacturing Technology III (American Feed Industry Association, Arlington Va. McEllhiney, R. R. (technical Editor). 1985. Appendix G Wafers, Pellets, and Crumbles-Definitions and methods for determining specific weight, durability, and moisture content; Section 6 Durability; Paragraph 2, Pellets and crumbles) the disclosure of which is herein incorporated by reference. The procedure includes the following steps:

Obtain a composite product sample by obtaining several samples at regular intervals throughout production. The samples should be mixed together for testing.

Screen sample with the appropriate screen as set forth on the Screen Sizes for Pellet and Crumbles Durability Tests, by shaking it 30 times.

Place a 500-gram sample (+/−10 grams) in a tumbler compartment.

Tumble sample 500 turns in 9.5 to 10 minutes.

Screen sample with the appropriate screen as set forth on the Screen Sizes for Pellet and Crumbles Durability Tests by shaking it approximately 30 times.

Document the amount of sample and the amount of screened product.

i)

Agglomerated feed as aforementioned, wherein the agglomerates of said agglomerated feed exhibit an average break threshold of at least 6 N when subjected to a compression force.

The breaking strength is preferably determined with a compression tests. Single agglomerates are compressed with a tooth shaped aluminium tool (Volodkevich Bite Jaw, 10 mm wide, 2 mm thick with rounded edges) operating at a velocity of 0.5 mm/s. From the registered force deformation curve the maximum force at failure in N was registered as breaking strength. The breaking strength is expressed as average of at least 10 measurements.

j)

Method for producing agglomerated feed, in particular according to any one of items a) to i) above, comprising the steps of:

providing particles having an average size in the range of d50=0.8 mm to d50=2.5 mm, preferably of d50=1 mm to d50=2.2 mm, more preferably of d50=1.1 mm to d50=2.0, particularly preferred of d50=1.2 to d50=1.8 mm,

agglomerating the particles by means of shear, moisture and heat such that the agglomerated particles Obtained have an average size the range of d50=1.0 mm to d50=5.5 mm, preferably of d50=1.5 mm to d50=4.5 mm, more preferably of d50=2.0 mm to d50=4 mm, particularly preferred of d50=2.5 to d50=3.5 mm.

k)

Method as aforementioned, wherein agglomeration is carried out in a pellet press.

l)

Method as aforementioned, wherein the agglomeration is carried out in an expander or extruder, in particular a single shaft or twin screw extruder.

m)

Use of agglomerated feed defined as aforementioned and/or produced with a method as aforementioned as feed for poultry.

n)

Method of feeding poultry, comprising the step of feeding poultry with agglomerated feed defined as aforementioned and/or produced with a method as aforementioned.

### EXAMPLE 1 (ACCORDING TO THE INVENTION)

These ingredients of starter feed for poultry (standard recipe) were agglomerated as outlined hereinbefore; the grain (here: corn) was provided with a particle size in the range as outlined hereinbefore:

| Ingredients | Weight % |
|---|---|
| Corn | 52 |
| Soybean Meal (48%) | 35 |
| Starch/Pregel | — |
| Soy Oil | 6 |
| Meat and Bone Meal | 4 |
| Limestone | 1 |
| Dicalcium phosphate | 1 |
| NaCl | 0.5 |
| Feed additives | (rest to 100 weight %) |

### EXAMPLE 2 (ACCORDING TO THE INVENTION)

These ingredients of normal feed for poultry (standard recipe) were agglomerated as outlined hereinbefore; the grain (here: corn) was provided with a particle size in the range as outlined hereinbefore):

| Ingredients | Weight % |
|---|---|
| Corn | 62 |
| Soybean Meal (48%) | 27 |
| Starch/Pregel | — |
| Soy Oil | 6 |
| Meat and Bone Meal, porcine | 4 |
| Limestone | 1 |
| Dicalcium phosphate | 1 |
| NaCl | 0.5 |
| Feed additives | (rest to 100 weight %) |

### EXAMPLE 3 (ACCORDING TO THE INVENTION)

Ingredients of starter, normal and final feed fed to poultry, for poultry production; the ingredients were agglomerated as outlined hereinbefore; the grain (here: corn) was provided with a particle size in the range as outlined hereinbefore):

| | | Starter | Normal | Final |
|---|---|---|---|---|
| | | feed | feed | feed |
| | | Starter | C | C |
| Feed-Nr. | Unit | 7910 | 7918 | 7924 |
| Corn grinded | % | 36 | 10 | 10 |
| Soy extract | % | 28 | 28 | 28 |
| NaCl | % | 0.1 | 0.1 | 0.1 |
| Animal fat | % | — | 3.0 | 3.0 |
| Limestone | % | 1.0 | 1.0 | 1.0 |
| Corn coarse | % | 20 | 50 | 50 |
| Dicalcium phosphate | % | 1.17 | 1 | 1 |
| Soy oil | % | 7 | 2.32 | 2.42 |
| Sodium carbonate | % | 0.2 | 0.2 | 0.2 |
| Meth-MHA | % | 0.3 | 0.3 | 0.3 |
| Threonine | % | 0.1 | 0.1 | 0.1 |
| Herring meal | % | 3 | 3 | 3 |
| Potato protein | % | 2 | — | — |
| Choline L | % | 0.1 | 0.05 | 0.05 |
| L-Lysin | % | 0.2 | 0.1 | 0.1 |
| Ronozyme ® | % | 0.02 | 0.02 | 0.02 |
| Hostazyme ® | % | 0.01 | 0.01 | 0.01 |
| Vitamins (Mix) | % | 0.3 | 0.3 | 0.3 |
| Monteban ® | % | 0.1 | 0.1 | |
| Lupro-Cid ® | % | 0.2 | 0.2 | 0.3 |
| Micronutrients and | % | 0.2 | 0.2 | 0.2 |
| mineral nutrients (Mix) | | | | |
| Total | % | 100 | 100 | 100 |

For poultry farming lasting for example 37 days to grow the poultry, starter feed is fed from day 1 to day 10, normal feed from day 11 to day 32 and final feed from day 33 to day 37.

It has surprisingly been found that the right combination of particle size and agglomerate size as defined hereinbefore has a positive nutritional effect. This was not expected since today's industry combines particle size and agglomerate size in a different way today; no beneficial effect of a specific combination of particle size and agglomerate size has been reported by now, to the best of applicant's knowledge.

What is claimed is:

1. Agglomerated feed comprising agglomerated particles, wherein:
grain particles have an average size in the range of d50=0.8 mm to d50=2.5 mm, preferably of d50=1 mm to d50=2.2 mm, more preferably of d50=1.1 mm to d50=2.0, particularly preferred of d50=1.2 to d50=1.8 mm;
wherein said agglomerated particles have an average size in the range of d50=1.0 mm to d50=5.5 mm, preferably of d50=1.5 mm to d50=4.5 mm, more preferably of d50=2.0 mm to d50=4 mm, particularly preferred of d50=2.5 to d50=3.5 mm.

2. Agglomerated feed according to claim 1, wherein the grain is corn.

3. Agglomerated feed according to claim 1, comprising at least one of the ingredients: soybean meal, soy oil, rape seed meal, meat and bone meal, limestone, dicalcium phosphate, salt, DL-methionine, sodium carbonate, threonine, herring meal, potato protein, choline L, L-lysin, enzymes for amelioration of intestinal flora, acids, vitamins, preservative agents, Monteban®.

4. Agglomerated feed according to claim 1, wherein the gelatinization of starch comprised in said agglomerated feed is less than 25%, preferably less than 21% and more preferably less than 18%.

5. Agglomerated feed according to claim 1, wherein the density of an agglomerate of said agglomerated feed is less than 1.6 g/ml, preferably less than 1.48 g/ml, more preferably less than 1.42 g/ml and particularly preferred less than 1.36 g/ml; in any case, the density of the agglomerated feed is higher than 0.1 g/ml.

6. Agglomerated feed according to claim 1, wherein said agglomerated feed exhibits an abrasion resistance when subjected to shear forces according to Schulze such that at a normal pressure of 10,000 Pa and a shear distance of 25 cm the d90 of said agglomerated feed is reduced to the range of about 1 mm to about 2 mm in absolute values; and/or the d90 of said agglomerated feed is reduced to the range of about 1 mm to about 2 mm in relation to the absolute values of the sample prior to the abrasion test.

7. Agglomerated feed according to claim 1, wherein said agglomerated feed exhibits an abrasion resistance when subjected to shear forces according to Schulze, such that at a normal pressure of 20,000 Pa and a shear distance of 25 cm, the d90 of said agglomerated feed is reduced to below about 1 mm in absolute values; and/or the d90 of said agglomerated feed is reduced to below about 1 mm in relation to the absolute values of the sample prior to the abrasion test.

8. Agglomerated feed according to claim 1, wherein said agglomerated feed has a PDI of at least 70%, preferably of at least 80%, more preferably of at least 90%, even more preferably of at least 95% and most preferably of at least 99%.

9. Agglomerated feed according to claim 1, wherein the agglomerates of said agglomerated feed exhibit an average break threshold of at least 6 N when subjected to a compression force.

10. Agglomerated feed according to claim 1, being feed for poultry.

11. A method for producing agglomerated feed, in particular according to claim 1, comprising the steps of:
providing particles having an average size in the range of d50=0.8 mm to d50=2.5 mm, preferably of d50=1 mm to d50=2.2 mm, more preferably of d50=1.1 mm to d50=2.0, particularly preferred of d50=1.2 to d50=1.8 mm,
agglomerating the particles by means of shear, moisture and heat such that the agglomerated particles obtained have an aver-age size the range of d50=1.0 mm to d50=5.5 mm, preferably of d50=1.5 mm to d50=4.5 mm, more preferably of d50=2.0 mm to d50=4 mm, particularly preferred of d50=2.5 to d50=3.5 mm.

12. A method according to claim 11, wherein agglomeration is carried out in a pellet press.

13. A method according to claim 11, wherein the agglomeration is carried out in an expander or extruder, in particular a single shaft or twin screw extruder.

14. A method of feeding poultry, comprising a step of feeding poultry with agglomerated feed according to claim 1 and/or produced by the method of claim 11.
